(19) United States
(12) Patent Application Publication
(10) Pub. No.: US 2025/0111278 A1
(43) Pub. Date: Apr. 3, 2025

(54) METHOD, APPARATUS, DEVICE AND STORAGE MEDIUM FOR PROCESSING INFORMATION

(71) Applicant: Beijing Zitiao Network Technology Co., Ltd., Beijing (CN)

(72) Inventors: Jie MEI, Beijing (CN); Mian LIU, Beijing (CN); Junli XIAN, Beijing (CN); Lu ZHANG, Beijing (CN); Peng WU, Beijing (CN); Zeng GAO, Beijing (CN); Wei DONG, Beijing (CN)

(21) Appl. No.: 18/891,759

(22) Filed: Sep. 20, 2024

(30) Foreign Application Priority Data
Sep. 28, 2023 (CN) 202311279490.9

(51) Int. Cl. G06N 20/00

(52) U.S. Cl. CPC G06N 20/00

(57) ABSTRACT

The embodiment of the invention provides a method, apparatus, device and a storage medium for processing information. In the method, aggregation information associated with a target object is generated based on historical interaction information of the target object, the historical interaction information being generated based on a set of interaction events between the target object and at least one service component; and the aggregation information is provided for interaction between the target object and a digital assistant. Thus, by generating a response to the digital assistant based on the historical interaction information between the target object and the service component, embodiments of the present disclosure can improve the quality of the response content generated by the digital assistant.

### CROSS REFERENCE

This application claims priority of the Chinese patent application No. 2023112794909,entitled “METHOD, APPARATUS, DEVICE AND STORAGE MEDIUM FOR PROCESSING INFORMATION” filed on Sep. 28, 2023, the entire content of which is incorporated herein by reference.

### FIELD

Example embodiments of the present disclosure generally relate to the field of computers, and in particular, to a method, an apparatus, a device, and a computer-readable storage medium for processing information.

### BACKGROUND

With the rapid development of Internet technologies, the Internet has become an important platform for people to obtain and share content, and users can access the Internet through terminal devices to share various Internet services.

In addition, the Internet platform can also provide user with capabilities related to various types of information processing. How to improve the accuracy of such information processing has become people's focus of attention.

### SUMMARY

In a first aspect of the present disclosure, a method of processing information is provided. The method comprises: generating aggregation information associated with a target object based on historical interaction information of the target object, the historical interaction information being generated based on a set of interaction events between the target object and at least one service component; and providing the aggregation information for interaction between the target object and a digital assistant.

In a second aspect of the present disclosure, a method of processing information is provided. The method comprises: determining time information of an interaction between a target object and a digital assistant; and providing at least one content to the target object with the digital assistant based at least on the time information, the at least one content being determined based on a matching between the time information and aggregation information, the aggregation information being generated based on historical interaction information between the target object and at least one service component.

In a third aspect of the present disclosure, a method of processing information is provided. The method comprises: receiving first information input by a target object to a digital assistant, the first information indicating a content creation requirement; and providing a creation content to the target object with the digital assistant, the creation content being generated based on aggregation information associated with the target object, the aggregation information being generated based on historical interaction information between the target object and at least one service component.

In a fourth aspect of the present disclosure, an apparatus for processing information is provided. The apparatus comprises: a generation module, configured to generate aggregation information associated with a target object based on historical interaction information of the target object, the historical interaction information being generated based on a set of interaction events between the target object and at least one service component; and a first provision module configured to provide the aggregation information for interaction between the target object and a digital assistant.

In a fifth aspect of the present disclosure, an apparatus for processing information is provided. The apparatus comprises: a determination module configured to determine a target time of interaction between a target object and a digital assistant; and a second provision module, configured to provide at least one content to the target object by the digital assistant based at least on the target time, the at least one content being determined based on a match between the target moment and aggregation information, the aggregation information being generated based on historical interaction information between the target object and at least one service component.

In a sixth aspect of the present disclosure, an apparatus for processing information is provided. The apparatus comprises: a receiving module, configured to receive first information input by a target object to a digital assistant, the first information indicating a content creation requirement; and a third provision module configured to provide a creation content to the target object by the digital assistant, the creation content being generated based on aggregation information associated with the target object, the aggregation information being generated based on historical interaction information between the target object and at least one service component.

In a seventh aspect of the present disclosure, an electronic device is provided. The device includes at least one processing unit; and at least one memory coupled to the at least one processing unit and storing instructions for execution by the at least one processing unit. The instructions, when executed by the at least one processing unit, cause the device to perform the method of the first aspect, the second aspect, or the third aspect.

In an eighth aspect of the present disclosure, a computer-readable storage medium is provided. The computer-readable storage medium stores a computer program, and the computer program is executable by the processor to implement the method according to the first aspect, the second aspect, or the third aspect.

It should be understood that the content described in this content section is not intended to limit the key features or important features of the embodiments of the present disclosure, nor is it intended to limit the scope of the present disclosure. Other features of the present disclosure will become readily understood from the following description.

### BRIEF DESCRIPTION OF DRA WINGS

The above and other features, advantages, and aspects of various embodiments of the present disclosure will become more apparent from the following detailed description taken in connection with the accompanying drawings. In the drawings, the same or similar reference numbers refer to the same or similar elements, wherein:

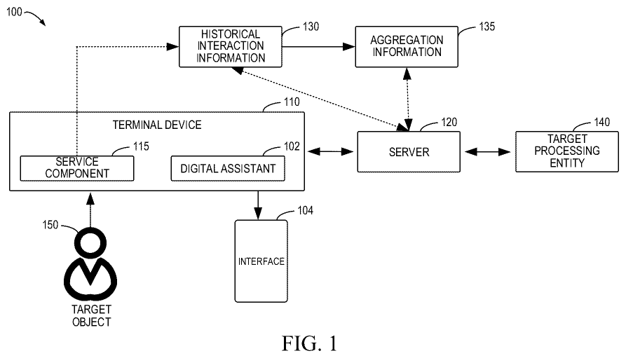

FIG. 1 illustrates a schematic diagram of an example environment in which embodiments of the present disclosure can be implemented;

FIG. 2 illustrates a flowchart of a method for processing information according to some embodiments of the present disclosure;

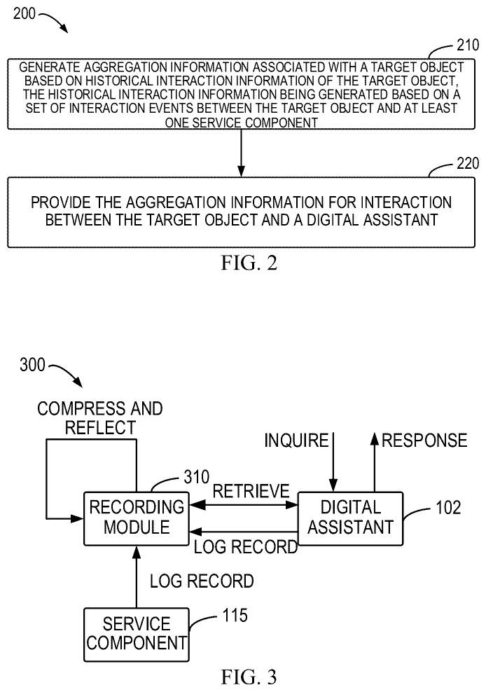

FIG. 3 illustrates an example system architecture according to some embodiments of the present disclosure;

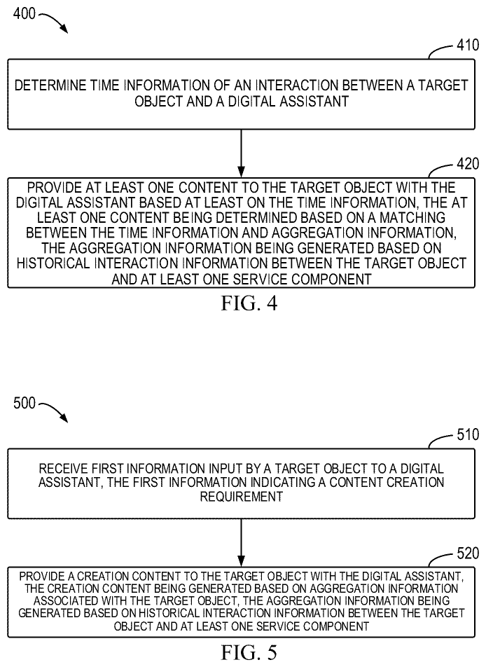

FIG. 4 illustrates a flowchart of a method for processing information according to some embodiments of the present disclosure;

FIG. 5 illustrates a flowchart of a method for processing information according to some embodiments of the present disclosure;

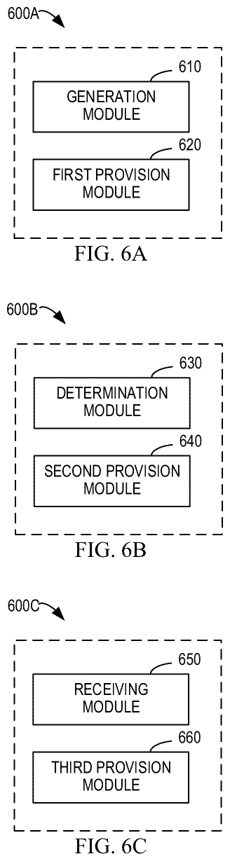

FIGS. 6A, 6B, and 6C illustrate block diagrams of an apparatus for processing information according to some embodiments of the present disclosure; and

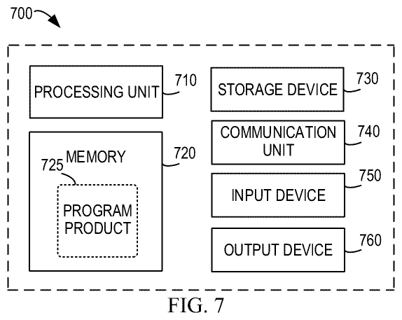

FIG. 7 illustrates a block diagram of a device capable of implementing various embodiments of the present disclosure.

### DETAILED DESCRIPTION

It is to be understood that, before the technical solutions disclosed in the embodiments of the present disclosure are used, the related users should be informed of the type, range of application, the usage scenario, and the like of the information related to the present disclosure in an appropriate manner in accordance with relevant laws and regulations and the authorization of the related users should be obtained. The related users may include any type of right subjects, such as individuals, enterprises, organizations.

For example, in response to receiving an active request from a user, prompt information is sent to the relevant user to explicitly prompt the relevant user that the operation requested by the user to be performed will need to obtain and use the information of the relevant user. Therefore, the related user can autonomously select whether to provide information to software or hardware such as electronic device, application, server or storage medium and the like, executing the operation of the technical solution of the present disclosure according to the prompt information.

As an optional but non-limiting implementation, in response to receiving an active request of a related user, a manner of sending prompt information to the related user may be, for example, a pop-up window, and prompt information may be presented in a text manner in the pop-up window. In addition, the pop-up window may further carry a selection control for the user to select “agree” or “not agree” to provide information to the electronic device.

It may be understood that the foregoing notification and obtaining a user authorization process is merely illustrative, and does not constitute a limitation on implementations of the present disclosure, and other manners of meeting related laws and regulations may also be applied to implementations of the present disclosure.

It is to be understood that, when the technical solution is used, the data involved (including but not limited to the data itself, the data acquisition, use, storage, and transmission) should follow the requirements of the corresponding laws and regulations and related regulations.

The term “in response to” as used herein means a state in which a respective event occurs, or condition is satisfied. It will be appreciated that the timing of execution of a subsequent action performed in response to the event or condition is not necessarily strongly correlated with the time at which the event occurs, or the condition holds. For example, in some cases, subsequent actions may be performed immediately when an event occurs or a condition holds; while in other cases, subsequent actions may be performed after a period of time elapses after an event occurs or a condition holds.

Embodiments of the present disclosure will be described in more detail below with reference to the accompanying drawings. While certain embodiments of the present disclosure are shown in the accompanying drawings, it should be understood that the present disclosure may be implemented in various forms, and should not be construed as limited to the embodiments set forth herein, but rather, these embodiments are provided for a more thorough and complete understanding of the present disclosure. It should be understood that the drawings and embodiments of the present disclosure are for illustrative purposes only and are not intended to limit the scope of the present disclosure.

It should be noted that the headline of any section/subsection provided herein is not limiting. Various embodiments are described throughout, and any type of embodiments may be included in any section/subsection. Furthermore, the embodiments described in any section/subsection may be combined in any manner with any other embodiment described in the same section/subsection and/or any other embodiment described in different sections/subsections.

In the description of the embodiments of the present disclosure, the terms “including” and the like should be understood to include “including but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definition may also be included below. The terms “first,” “second,” and the like may refer to different or identical object. Other explicit and implicit definition may also be included below.

As used herein, the term “model” may learn associations between respective inputs and outputs from training data such that corresponding outputs may be generated for a given input after training is complete. The generation and use of the model may be based on the technology allowed by laws and regulations such as machine learning and the like, which may be referred to as usable technologies for short. As an example, deep learning is a machine learning algorithm that processes inputs and provides corresponding outputs by using a multi-layer processing unit. “Model” may also be referred to herein as a “machine learning model,” “machine learning network,” or “network,” which terms are used interchangeably herein. A model may in turn include different types of processing units or networks.

As briefly mentioned above, various types of information processing tools have been utilized to improve the efficiency of information processing. For example, some digital assistants can generate respective responses based on dialog interactions with the user (e.g., text or speech).

However, such information processing procedures are often a generalization capability, which makes the task types that the digital assistant can handle being limited.

Embodiments of the present disclosure provide a solution for processing information. Specifically, aggregate information associated with the target object is generated based on historical interaction information of the target object (for example, the user or the termination), wherein the historical interaction information is generated based on a set of interaction events between the target object and the at least one service component. Further, aggregate information may be provided for interaction between the target object and the digital assistant.

Therefore, the embodiments of the present disclosure can obtain the aggregation information by refining the historical interaction information between the target object and the service component, so as to be used for interaction of the digital assistant, thereby supporting the digital assistant to provide richer interaction capability.

Example embodiments of the present disclosure are described below with reference to the accompanying drawings.

### EXAMPLE ENVIRONMENT

FIG. 1 illustrates a schematic diagram of an example environment 100 in which embodiments of the present disclosure can be implemented. As shown in FIG. 1, in environment 100, terminal device 110 may be utilized to provide digital assistant 102 for target object 150. Such target objects may include users or organizations, etc., where the organization may be an enterprise, group, department, or the like.

For example, such a digital assistant 102 may also be referred to as a digital assistant, or a digital robot. It should be understood that while the digital assistant 102 is shown included in the terminal device 110 in FIG. 1, the part of the processing capability of the digital assistant 102 may also be based at least in part on the server 120, for example. For example, a front end portion (e.g., a portion for presentation) of the digital assistant 102 may be included in the terminal device 110, but a back end portion (e.g., a portion for processing information) of the digital assistant 102 may be included in the server 120.

In some examples, the digital assistant 102 may be, for example, a digital assistant that assists the target object 150 in, for example, office, or may be in any other suitable form of entity. The digital assistant 102 may also operate independently or be integrated into a particular application.

In some embodiments, the digital assistant 102 may be enabled, such as, invoked or awakened in an appropriate manner (e.g., a shortcut key, button, or voice). If the digital assistant 102 is active, the terminal device 110 may present the interface 104 associated with the digital assistant 102. The interface 104 may be in a style of a conversational user interface (also referred to as a session interface or a session window), or may be any other suitable form of interface. As will be described in detail below, such an interface 104 may also include interface elements for information interaction, such as message input boxes, message lists, message bubbles, and the like. Through the interface 104, the digital assistant 102 may obtain information (also referred to as first information) input by the target object 150.

Such input information may include, for example, any suitable type of message, such as a text message, a picture message, a voice message, a table message, a link message, other suitable types of messages, and the like.

Further, the server 120 may allow the target object 150 to interaction with the digital assistant 102 to obtain information generated by the digital assistant 102. Alternatively, in a scenario where the authorization of the target object 150 is obtained, the information generated by the digital assistant 102 may also be based on historical interaction between the target object 150 and the at least one business component 115, as will be described in detail below. For example, the digital assistant 102 may process the first information with historical interaction information 130 generated based on historical interaction event between the target object 150 and the at least one service component 115.

Such service component 115 may include components capable of providing appropriate types of business services for the target object 150, examples of which may include, but are not limited to, office type components, tool type components, and the like. In some embodiments, such service components may be installed on the same terminal device 110. Alternatively or additionally, such service components may also be installed on other terminal devices, or provided in a cloud service manner.

In some embodiments, such service components 115 may include a plurality of office components in an office suite. An office suite may be a suite of office components developed to improve office efficiency, such as office components that create and edit documents, office components that create and edit tables, office components for drawing, and the like.

In some embodiments, the plurality of office components includes a plurality of the following: a chat component, a document component, an audio and video conference component, a mail component, a calendar component, a schedule component, a task component, an objectives and key results (OKR) component, and/or an appropriate office component currently available or possibly developed in the future.

In some embodiments, the digital assistant 102 may be a separate application different from the service component 115. Alternatively, the digital assistant 102 may also be a function or component suitably integrated into the service component 115.

In some embodiments, the historical interaction information 130 may be maintained at appropriate electronic devices as needed, such as the terminal device 110, the server 120, and/or other suitable electronic devices. The historical interaction information 130 may include, for example, interaction information stored on the terminal device 110 or interaction information that has been uploaded to the server 120.

In some embodiments, aggregation information 135 may also be generated based on the reflect of historical interaction information 130. Further, the digital assistant 102 may also utilize the aggregation information 135 to interaction with the target object 150.

As will be described in detail below, historical interaction information 130 and/or aggregation information 135 may be provided for interaction between digital assistant 102 and target object 150. As an example, the digital assistant 102 may obtain input information of the target object 150, and the digital assistant 102 or the server 120 may generate corresponding information (also referred to as third information) based on the input information and the historical interaction information 130 and/or the aggregation information 135.

Further, the server 120 or the digital assistant 102 may send the generated third information to the target processing entity 140. Further, the server 120 or the digital assistant 102 may generate corresponding information (also referred to as second information) based on the information returned by the target processing entity 140 (that is, the processing result for the third information). Such second information may, for example, be presented to the target object 150 via an interface 104 corresponding to the digital assistant 102.

The target processing entity 140 may be a processing entity based on a suitable information processing technology, and may implement one or more functions such as text generation, image generation, summarization, encoding, translation, and chatting. The target processing entity 140 may also be any other suitable entity form.

In some embodiments, terminal device 110 communicates with server 120 to enable provision of services to digital assistant 102. The terminal device 110 may be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the terminal device 110 can also support any type of interface (such as a “wearable” circuit, etc.) for the target object 150. The server 120 may be various types of computing systems/servers capable of providing computing power, including, but not limited to, mainframes, edge computing nodes, computing devices in a cloud environment, and the like.

Although only one server 120 is shown in FIG. 1, the environment 100 may include a plurality of servers 120. For example, the historical interaction information 130 may be stored locally or in the second server 120 according to needs and related user authorization, and the target processing entity 140 runs on the third server 120. It should be understood that the description herein is merely illustrative and does not imply any limitation on the scope of the present disclosure.

It should be understood that the structure and function of the environment 100 is described for illustrative purposes only and does not imply any limitation to the scope of the present disclosure.

### EXAMPLE PROCESSES

FIG. 2 illustrates a flowchart of a process 200 for information processing according to some embodiments of the present disclosure. Process 200 may be implemented by a suitable electronic device or a combination of electronic devices (e.g., server 120, terminal device 110, or a combination of server 120 and terminal device 110 in FIG. 1). For ease of description, the process 200 is described below by using the server 120 as an example and referring to FIG. 1.

At block 210, the server 120 generate aggregation information 135 associated with a target object 150 based on historical interaction information 130 of the target object 150, the historical interaction information 130 being generated based on a set of interaction events between the target object 150 and at least one service component 115.

The generation and management processes of the historical interaction information 130 and the aggregation information 135 are described below with reference to FIG. 3, which illustrates an example system architecture 200 according to an embodiment of the present disclosure.

As shown in FIG. 3, when the target object 150 interacts with the service component 115, the service component 115 may generate a log record, and send the log record to the recording module 310.

Further, the recording module 310 may generate a corresponding record entry based on the received log record, and construct a record library as the historical interaction information. In some embodiments, such record entries may include knowledge elements for describing service object corresponding to the historical interaction event. In some embodiments, the record library may be maintained at an appropriate electronic device process, which may be stored at the terminal device 110, for example, or stored at the server 120.

In some embodiments, such a service object may include service object, edited service objects, referenced service objects, shared service objects, and the like generated during interaction between the target object 150 and the service component 115. Taking the service component 115 being a document component as an example, the historical interaction event may include a creation event of the target object 150 on a specific document in the document component. Accordingly, the service object corresponding to the document creation event is the specific document.

In some embodiments, the knowledge element may be a natural language description about

the service object, which is intended to abstract and/or compress the content of the service object. For example, the document object is used as an example of a service object, and the knowledge element may be used to describe a theme, a completion status, an audience, a language, an expression style, and the like of the document object.

It should be understood that information of different dimensions may be selected based on different types of service object to generate a knowledge element for describing the service object. For example, take a session as an example of a service object, a knowledge element may be used. for example, to describe a type of the session (e.g., whether it is a single chat), a summary of a session, or the like.

Thus, by maintaining a knowledge element in a record entry, embodiments of the present disclosure may describe or characterize a service object involved in a corresponding historical interaction event through a limited content length.

In some embodiments, the record entry may further include a time element for indicating an occurrence time of the historical interaction event. For example, continuing to take creating a document as an example of a historical interaction event, such a time element may, for example, indicate a creation time of the document.

In still other embodiments, the record entry may also include an action element for indicating an event type of the historical interaction event. Continuing to take creating a document as an example of a historical interaction event, such action elements may, for example, indicate that the type of the historical interaction event is a “create” type.

In some embodiments, the record entry may also include load elements for indexing service object corresponding to respective historical interaction event. Taking a document as an example of a service object, the load element may include, for example, a document number or a document identifier used to index the document.

Thus, in some scenarios, after the target object 150 interacts with the service component 115, the recording module 310 may generate a corresponding record entry. Such a record entry may be represented, for example, as {time element, action element, knowledge element, load element}, to describe the historical interaction event from a plurality of predetermined dimensions.

Based on such a manner, the recording module 310 may support interaction between the target object 150 and the digital assistant 102 by maintaining a set of record entries in the record library. Such a record library may also be similar to the “memory information” of the digital assistant, helping the digital assistant to increase the quality of the generated response content.

In some embodiments, considering that there are more and more interactions between the target object 150 and the service component 115, the size of the corresponding record library will be larger and larger. To manage the historical interaction information more effectively, the recording module 310 may also perform compression processing on the record entries.

For example, the recording module 310 may, for example, periodically compress the record entries in the record library to compress the plurality of record entries into one record compression entry. For example, the recording module 310 may perform compression processing of the record entry according to the occurrence time of the historical interaction event.

In some embodiments, in a scenario where the plurality of historical interaction events have occurred longer than the threshold duration (e.g., one month), the recording module 310 may remove the record entries of the plurality of historical machine interaction event from the record library, and generate a corresponding record compression entry.

For example, the recording module 310 may identify a set of record entries to be compressed from a record library, such set of record entries to be compressed may correspond to, for example, an associated interaction event (for example, associated with a same service object) whose occurrence date has exceeded a threshold duration.

For example, the target object 150 may create, edit, and share a document A within a week, a month ago. Accordingly, three record entries corresponding to these three historical interaction events may be previously maintained in the record library. Further, the recording module 310 may compress the three record entries into a single record compression entry upon determining that the three historical interaction events occurred one month ago.

In the process of compressing the plurality of record entries into a single record compression entry, the record module 310 may, for example, retain only important information in the plurality of record entries, thereby reducing the storage and management consumption of the record entries.

In some embodiments, the manner of compressing the record entry may further include, for example, retaining a part of record entries in the record entry to be compressed. Continuing to take the example of creating, editing, and sharing the document A, the recording module 310 may, for example, only retain a record entry corresponding to the “Edit document A”, which may also be referred to as a record compression entry.

Such a recording manner can also be similar to a management manner of human memory, that is, for a historical event with an earlier time, the recording module may maintain relatively fuzzy record information, and conversely, for a historical event with a closer time, the recording module may maintain more accurate record information.

In some embodiments, the recording module 310 may, for example, utilize a compression model to achieve compression for the recording entries. Specifically, the recording module 310 may, for example, provide the plurality of record entries to be compressed to the record model to obtain record compression entries corresponding to the plurality of record entries to be compressed. Such a compression model may be implemented with an appropriate machine learning model.

In some examples, the compression model may be the target processing entity 140 discussed with reference to FIG. 1. That is, the recording module 310 may obtain a compressed record compression entry by providing the target processing entity 140 with a prompt and a plurality of record entries to be compressed for instructing the target processing entity 140 to perform the compression. For example, such a prompt may be “Please select the most representative three record entries from a plurality of record entries below” or “Please compress the following plurality of record entries into a single entry”.

In this way, the recording module 310 may, for example, periodically compress the record entries to reduce the management and maintenance costs of the record entries.

In some embodiments, with the knowledge and authorization of the target object 150, the recording module 310 may further reflect the record entry to generate aggregation information 135 associated with the target object 150.

In some embodiments, the recording module 310 may determine a correlation between at least two of the plurality of elements in the historical interaction information 130, and may generate the aggregation information 135 to indicate the correlation.

For example, such aggregation information 135 may indicate a correlation between a time element and an action element. For example, the recording module 310 may analyze the plurality of record entries in the historical interaction information 130 to determine a correlation between the time element and the action element, e.g., “compose a weekly report on each Monday afternoon”.

As another example, such aggregation information 135 may also indicate a correlation between action elements and knowledge elements. For example, the recording module 310 may analyze the plurality of record entries in the historical interaction information 130 to determine a correlation between the action element and the knowledge element, for example, the “document A has updated the following content: XXX” for last one month.

In this manner, embodiments of the present disclosure may generate aggregation information 135 by reflecting correlation of different elements.

In some embodiments, the aggregation information 135 may be used to describe characteristics of the target object 150 and/or characteristics of associated entities of the target object 150.

Specifically, the recording module 310 may reflect the aggregation information at different levels. For example, the recording module 310 may reflect the working characteristics of the target object 150, for example, “the target object composes the weekly report weekly on each Monday afternoon”.

As another example, the recording module 310 may also reflect the characteristics of the associated entity of the target object. Such an associated entity may include a group associated with the target object, an organization associated with the target object, or a project associated with the target object.

For example, the recording module 310 may reflect the characteristics of the project in

which the target object 150 participates. For example, the aggregation information 135 may indicate an summary of the item, e.g., the progress of the project, the next plan, the responsible personal, etc.

As another example, the recording module 310 may reflect the characteristics of the organization (e.g., department) where the target object 150 is located. For example, the aggregation information 135 may indicate the primary work done by the department in the last month.

In this way, the recording module 310 may reflect information such as knowledge elements and action elements from different levels, so as to obtain aggregation information corresponding to different levels.

In some embodiments, the recording module 310 may, for example, utilize an aggregation model to generate the aggregation information 135. Specifically, specifically, the recording module 310 may generate the information to be provided to the aggregation model based on the historical interaction information 130. For example, a plurality of record entries to be reflected may be provided to the aggregation model to obtain one or more description entries corresponding to the plurality of record entries to be reflected. Such an aggregation model may be implemented with an appropriate machine learning model.

In some examples, the aggregation model may be the target processing entity 140 discussed with reference to FIG. 1. That is, the recording module 310 may provide the reflected aggregation information by providing, to the target processing entity 140, a prompt and a plurality of record entries to be reflected for instructing the target processing entity 140 to perform feature reflection.

Based on the foregoing manner, the recording module 310 may, for example, maintain one or more of a record entry corresponding to the historical interaction event, a record compression entry obtained by compressing record entry, and/or aggregation information obtained by reflecting the record entry, for the generation of the second information.

With continued reference to FIG. 2, at block 220, the server 120 provides the aggregation information for interaction between the target object and the digital assistant.

In some embodiments, the server 120 may utilize the target processing entity 140 to generate the second information, as discussed with reference to FIG. 1.

Specifically, the server 120 may process the first information to generate the third information based on the record entry, the record compression entry, and/or the aggregation information 135 maintained by the recording module 310. Further, the server 120 may provide third information to the target processing entity 140, wherein the target processing entity 140 is different from the digital assistant 102. Additionally, the server 120 may generate the second information based on the processing result of the target processing entity 140 for the third information.

In some embodiments, the target processing entity 140 may include a target model, for

example, a target language model. Accordingly, the third information may include, for example, input information to the target model. In some scenarios, such third information may also be referred to as a prompt word, a guidance word, or a prompt, etc., to the target model. It should be understood that, according to the need of actual scenarios, the target processing entity 140 may also include other suitable model, for example.

In some embodiments, the server 120 may process the first information based on a set of record entries included in the historical interaction information 130. In some embodiments, after the digital assistant 102 receives the first information (also referred to as query information) input by the target object 150, the server 130 may determine, from the set of record entries maintained by the recording module 310, at least one record entry associated with the first information.

It should be understood that any suitable technique may be utilized to determine at least one record entry associated with the first information. For example, the server 120 may determine, based on the semantic analysis of the first information, at least one record entry associated with the semantics of the first information from the set of record entries. Alternatively, the server 120 may also determine, from the record library, at least one record entry associated with the semantic of the first information, for example, based on a search or a match of the keyword.

As an example, the server 120 may determine at least one associated record entry based on a similarity between the record entry and the first information, for example. Specifically, the server 120 may determine a set of description vectors corresponding to a set of record entries maintained in the record library and a target description vector corresponding to the received first information. Further, the server 120 may determine, from the set of record entries, at least one record entry associated with the first information based on the target description vector and the set of description vectors corresponding to the set of record entries.

As an example, the server 120 may, for example, determine, from the set of record entries, a record entry whose angle between the corresponding description vector and the target description entry vector is less than a threshold, as the at least one record entry associated with the first information.

Accordingly, the server 120 may further generate third information to be provided to the target processing entity 140 based on the first information and the associated at least one record entry. For example, the server 120 may add additional information corresponding to the associated at least one record entry on the basis of reserving the first information to generate the third information. Illustratively, such additional information may be generated, for example, based on the associated at least one record entry.

For example, the server 120 may use all or part of the knowledge elements of the “document A” as third information to provide the third information to the target processing entity 140. For example, the server 120 may provide, to the target processing entity 140, the portion of “the language expression of the document is formal” that is used to represent the style information of the “document A” in the knowledge element 355, so that the target processing entity 140 can respond to the first information according to the style information.

As another example, the server 120 may further rewrite the first information based on the associated at least one record entry, for example, expand the first information, so that the first information can more accurately reflect the requirement of the target object 150.

In some embodiments, the server 120 may also process the first information based on a set of record compression entries included in the historical interaction information 130 to generate second information. Illustratively, similar to the process of determining the associated record entry, the server 120 may determine at least one record compression entry associated with the first information from the set of record compression entries maintained by the record module 310.

Further, the server 120 may generate the third information to be provided to the target processing entity 140 by using the determined at least one record compression entry and the first information. For example, the server 120 may add additional information corresponding to at least one associated record compression entry on the basis of reserving the first information to generate the third information. Illustratively, such additional information may be generated, for example, based on at least one associated record compression entry.

As another example, the server 120 may further rewrite the first information based on at least one associated record compression entry, for example, expand the first information, so that the first information can more accurately reflect the requirement of the target object 150.

In some embodiments, the server 120 may also process the first information based on the aggregation information 135 to generate second information. Such aggregation information 135 may include, for example, a set of description entries for describing different aspects. For example, the server 120 may determine, for example, at least one description entry associated with the first information from the set of description entries.

Further, the server 120 may generate the third information to be provided to the target processing entity 140 by using the determined at least one description entry and the first information. For example, the server 120 may add additional information corresponding to at least one associated description entry on the basis of reserving the first information to generate the third information. For example, such additional information may be generated based on at least one associated description entry, for example.

As another example, the server 120 may further rewrite the first information based on at least one associated description entry, for example, expand the first information, so that the first information can more accurately reflect the requirement of the target object 150.

Based on this manner, the embodiments of the present disclosure can generate third information that is more consistent with the interaction requirement of the target object 150 based on the aggregation information 135, and can improve the accuracy of information processing when the target object maintains its personal interaction habit.

Further, the terminal device 110 may further obtain second information generated based on the first information, and provide the second information to the target object 150 as a response to the first information.

The example process of generating the second information by the digital assistant 102 based on the first information input by the target object 150 is discussed above, based on the above manner, the embodiments of the present disclosure can improve the accuracy of information processing, so that the generated second information better conforms to the interaction habit and the requirement on the interaction result of the target object 150.

In some embodiments, after determining at least one description entry associated with the first information from the aggregation information 135, the server 120 may directly use the description entry to generate a response without utilizing the target processing entity 140.

The following describes a determination process that a related description entry is described in combination with first information of different requirement types. In some embodiments, the first information received by the digital assistant 102 may indicate a positional search requirement about a particular content. For example, the first information may be “please help to list my project weekly reports”.

Further, the server 120 may determine the matching first description entry from the aggregation information 135 based on the first information and/or the target attribute of the first information (for example, the event that the first information is received is Monday). For example, the first description entry may indicate historical interaction attribute information of the target object, for example, “the target object participates in the regular meeting of project A on each Monday afternoon”.

Accordingly, when providing the weekly report, the server 120 may preferentially provide the project weekly report about the “project A” as the corresponding recommendation content. Therefore, the recommendation content provided by the server 120 can more match the requirement of the target object. In some embodiments, the server 120 may directly utilize the aggregation information 135 to provide a project weekly report about the “project A”: alternatively, the server 120 may also process the first information with the determined first description entry to provide a project weekly report about the “project A” with the target processing entity 140.

Therefore, by using the aggregation information, embodiments of the present disclosure can respond to the positional search requirement of the target object more accurately.

In some embodiments, the first information received by the digital assistant 102 may indicate a content creation requirement about a particular content. For example, the target object 150 may input the following first information: “Please help to draft the weekly report of project A”.

Further, the server 120 may determine a second description entry matching the first information from the aggregation information 135, such second description entry may indicate the creation attribute information of the target object 150.

For example, the aggregation information 135 may include a second description entry, which may be generated based on the reflection of the creation style information for the composed weekly report within the past predetermined period of time for the target object 150. Further, the server 120 may, for example, directly generate the corresponding creation content based on the second description entry as the second information.

Alternatively, the server 120 may also process the first information by using the determined second description entry to use the target processing entity 140 to compose the corresponding weekly report draft as the second information. For example, the server 120 may provide the second description entry together with the first information to the target processing entity 140, so that the target processing entity 140 can generate the corresponding creation content according to the creation attribute information indicated by the second description entry.

In this way, the embodiments of the present disclosure can better match the creation attribute information of the target object, so that the generated content can better conform the expectations of the target object.

In some embodiments, the interaction between the digital assistant 102 and the target object 150 may not only include conversational interaction as discussed above, but may also include providing, by the digital assistant 102, corresponding recommendation content for the target object 150.

For example, the server 120 may generate the recommendation content for the target object 150 based on the aggregation information determined above, and provide the recommendation content to the target object 150 by the digital assistant 102.

As an example, such recommendation content may include at least one recommendation content for input to an appropriate input control associated with the digital assistant 102. For example, for a search input control in a document component, the digital assistant 102 may, for example, lunch a document component on the “Monday morning” according to the target object 150, and provide a document associated with the “project A” as recommendation content according to one description entry of “the target object participates in the regular meeting of project A each Monday afternoon” included in the aggregation information 135. For example, such recommendation content may include “want to search project A weekly report?” or the like. It should be understood that the search control is only an example of the input control, and may further include any other suitable input control.

As yet another example, such recommendation content may also include, for example, at least one recommendation content for input to the digital assistant 102, e.g., a recommended guidance word. For example, the digital assistant 102 may provide candidate guidance words, for example, “please draft the weekly report” on the “Monday afternoon” to the target object according to the description entry “the target object composes the weekly report each Monday afternoon” included in the aggregated information 135.

In this way, embodiments of the present disclosure can use the aggregation information to improve the interaction efficiency between the target object and the digital assistant.

FIG. 4 illustrates a flowchart of a method 400 for processing information according to some embodiments of the present disclosure. The method 400 may be implemented by a suitable electronic device or combination of electronic devices (e.g., the server 120, the terminal device 110, or a combination of the server 120 and the terminal device 110 in FIG. 1).

As shown in FIG. 4, at block 410, the electronic device (e.g., the server 120) determines time information of the interaction between the target object and the digital assistant.

For example, when the target object 150 interacts with the digital assistant 102, the time information corresponding to the interaction may be determined. Such time information may have suitable accuracy, e.g., a specific moment, a day, a month, etc.

At block 520, based at least on the time information, the electronic device (e.g., the server 120) utilizes the digital assistant to provide at least one content to the target object, wherein the at least one content is determined based on a match between the time information and the aggregation information, the aggregation information being generated based on historical interaction information between the target object and the at least one service component.

For a specific generation process of the historical interaction information, refer to the foregoing description, and details are not described again. Further, such aggregation information may be reflected based on the aggregation information. For example, such aggregation information may indicate a correlation between an occurrence time of a set of interaction events and an event type.

For example, the aggregation information may indicate that the “the target object participates in the regular meeting of project A each Wednesday afternoon”. Thus, based on the match between the aggregation information and the time information (e.g., Wednesday) corresponding to the interaction, the digital assistant 102 may actively provide a search guidance or content portal associated with the “project A”.

Alternatively, for the first information input by the target object 150, the digital assistant 102 may also perform a corresponding processing based on the time information matching the aggregation information. For example, if the information input by the target object 150 is “search the weekly report”. In the scenario that the time information (e.g., Wednesday) matches the aggregation information, the digital assistant 102 may, for example, preferentially provide a weekly report related to the “project A” as a response to the first information.

In this way, the embodiments of the present disclosure can improve the efficiency of the digital assistant information processing, and can make the provided content more meet the requirements of the target object.

FIG. 5 illustrates a flowchart of a method 500 of processing information according to some embodiments of the present disclosure. The method 500 may be implemented by a suitable electronic device or combination of electronic devices (e.g., the server 120, the terminal device 110, or a combination of the server 120 and the terminal device 110 in FIG. 1).

As shown in FIG. 5, in block 510, the electronic device (for example, the terminal device 110) receives first information input by the target object to the digital assistant, the first information indicating a content creation requirement.

As discussed above, the target object 150 may, for example, input the first information to the digital assistant 102, for example, “please help to draft the weekly report of project A”.

At block 520, creation content is provided to a target object using a digital assistant, the creation content being generated based on aggregation information associated with the target object, the aggregation information being generated based on historical interaction information between the target object and the at least one service component.

Further, the server 120 may determine a description entry matching the first information from the aggregation information 135, and such description entry may indicate the creation attribute information of the target object 150. For example, the aggregation information 135 may include a description entry, which may be generated based on the reflection of the creation style information of the composed weekly report within a past predetermined period of time for the target object 150. Further, the server 120 may, for example, directly generate the corresponding creation content based on the description entry as the second information.

Alternatively, the server 120 may also process the first information using the determined description entry to compose the corresponding weekly report draft using the target processing entity 140 as the second information. For example, the server 120 may provide the second description entry together with the first information to the target processing entity 140, so that the target processing entity 140 can generate the corresponding creation content according to the creation attribute information indicated by the second description entry.

Based on this manner, the embodiments of the present disclosure can support the digital assistant to generate the corresponding creation content according to the creation attribute information of the target object, so that the style thereof is more matched with the target object.

### EXAMPLE APPARATUS AND DEVICE

FIG. 6A illustrates a schematic structural block diagram of an apparatus 400 for processing information according to some embodiments of the present disclosure. The apparatus 600A may be implemented or included in the server 120, the terminal device 110, or a combination of the server 120 and the terminal device 110 of FIG. 1. The various modules/components in the apparatus 600A may be implemented by hardware, software, firmware, or any combination thereof.

As shown, the apparatus 600A comprises a generation module 610, configured to generate aggregation information associated with a target object based on historical interaction information of the target object, the historical interaction information being generated based on a set of interaction events between the target object and at least one service component; and a first provision module 620 configured to provide the aggregation information for interaction between the target object and a digital assistant.

In some embodiments, the historical interaction information comprises at least one of the following: a knowledge element for describing a service object corresponding to a respective interaction event; an action element for indicating an event type of the respective interaction event; and a time element for indicating an occurrence time of the respective interaction event.

In some embodiments, the historical interaction information comprises a plurality of elements corresponding to different types, and generating the aggregation information associated with the target object comprises: determining a correlation between at least two of the plurality of elements of the historical interaction information; and generating the aggregation information for indicating the correlation.

In some embodiments, the aggregation information is used to describe a characteristic of an associated entity of the target object and/or a characteristic of the target object.

In some embodiments, the associated entity of the target object comprises: a group associated with the target object; an organization associated with the target object; a project associated with the target object.

In some embodiments, the generation module 610 is further configured to: generate fourth information based on the historical interaction information; and provide the fourth information to an aggregation model to generate the aggregation information.

In some embodiments, the apparatus 600A further comprises an interaction module, configured to obtain first information input by the target object to the digital assistant; and generate, based at least on the first information and the aggregation information, second information as a response of the digital assistant to the first information.

In some embodiments, the interaction module is further configured to: process the first information based on the aggregation information to generate third information; provide the third information to a target processing entity; and generate the second information based on a processing result of the third information by the target processing entity.

In some embodiments, the third information comprises guidance information, and the target processing entity comprises a target model.

In some embodiments, the aggregation information comprises a set of description entries, and the interaction module is further configured to: determine at least one description entry associated with the first information from the set of description entries; and generate the second information based on the first information and the at least one description entry.

In some embodiments, the first information indicates a positional search requirement regarding a specific content, and the interaction module is further configured to: determining a matching first description entry from the set of description entries based on the first information and/or a target attribute of the first information, wherein the first description entry indicates historical interaction attribute information of the target object, wherein the generated second information indicates a recommendation content generated based on the first description entry.

In some embodiments, the first information indicates a content creation requirement, and the interaction module is further configured to: determine a matching second description entry from the set of description entries, wherein the second description entry indicates creation attribute information of the target object, the generated second information indicating a creation content generated based on the second description entry.

In some embodiments, the first information further indicates a historical content for reference, and the matching second description entry is generated based on a historical interaction event associated with the historical content.

In some embodiments, the apparatus 600A further comprises a recommendation module configured to: generate a recommendation content for the target object based on the aggregation information, to cause the digital assistant to provide the recommendation content.

In some embodiments, the recommendation content comprises at least one recommendation content for inputting to a target input control; and/or at least one recommendation content for inputting to the digital assistant.

FIG. 6B illustrates a schematic structural block diagram of an apparatus 400 for processing information according to some embodiments of the present disclosure. The apparatus 600B may be implemented as or included in the server 120, the terminal device 110, or a combination of the server 120 and the terminal device 110 of FIG. 1. The various modules/components in the apparatus 600B may be implemented by hardware, software, firmware, or any combination thereof.

As shown, the apparatus 600B comprises a generation module 610, configured to generate aggregation information associated with a target object based on historical interaction information of the target object, the historical interaction information being generated based on a set of interaction events between the target object and at least one service component; and a first provision module 630 configured to provide the aggregation information for interaction between the target object and a digital assistant.

In some embodiments, the historical interaction information is generated based on a set of interaction events between the target object and the at least one service component, and the aggregation information at least indicates a correlation between an occurrence time of the set of interaction events and an event type.

FIG. 6C illustrates a schematic structural block diagram of an apparatus 400 for processing information according to some embodiments of the present disclosure. The apparatus 600C may be implemented as or included in the server 120, the terminal device 110, or a combination of the server 120 and the terminal device 110 of FIG. 1. The various modules/components in the apparatus 600C may be implemented by hardware, software, firmware, or any combination thereof.

As shown, the apparatus 600C comprises a receiving module 650, configured to receive first information input by a target object to a digital assistant, the first information indicating a content creation requirement; and a third provision module 660 configured to provide a creation content to the target object by the digital assistant, the creation content being generated based on aggregation information associated with the target object, the aggregation information being generated based on historical interaction information between the target object and at least one service component.

In some embodiments, the historical interaction information is generated based on a set of interaction events between the target object and the at least one service component, the aggregation information at least indicates creation attribute information of the target object, and the creation attribute information is determined based on a creation attribute of at least one service object corresponding to the set of interaction events.

FIG. 7 illustrates a block diagram illustrating an electronic device 700 in which one or more embodiments of the present disclosure may be implemented. It should be understood that the electronic device 700 illustrated in FIG. 7 is merely illustrative and should not constitute any limitation on the functionality and scope of the embodiments described herein. The electronic device 700 shown in FIG. 7 may be configured to implement a combination of the server 120 and the terminal device 110, or the server 120 or the terminal device 110 in FIG. 1.

As shown in FIG. 7, the electronic device 700 is in the form of a general-purpose electronic device. Components of the electronic device 700 may include, but are not limited to, one or more processors or processing units 710, a memory 720, a storage device 730, one or more communication units 740, one or more input devices 750, and one or more output devices 760. The processing unit 710 may be an actual or virtual processor and capable of performing various processes according to programs stored in the memory 720. In a multiprocessor system, multiple processing units execute computer-executable instructions in parallel to improve parallel processing capabilities of electronic device 700.

The electronic device 700 typically includes a plurality of computer storage media. Such media may be any available media accessible to the electronic device 700, including, but not limited to, volatile and non-volatile media, removable and non-removable media. The memory 720 may be volatile memory (e.g., registers, caches, random access memory (RAM)), non-volatile memory (e.g., read-only memory (ROM), electrically erasable programmable read-only memory (EEPROM), flash memory), or some combination thereof. Storage device 730 may be a removable or non-removable medium and may include a machine-readable medium, such as a flash drive, magnetic disk, or any other medium, which may be capable of storing information and/or data and may be accessed within electronic device 700.

The electronic device 700 may further include additional removable/non-removable, volatile/non-volatile storage media. Although not shown in FIG. 7, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interface. The memory 720 may include a computer program product 725 having one or more program modules configured to perform various methods or actions of various embodiments of the present disclosure.

The communication unit 740 is configured to communicate with another electronic device through a communication medium. Additionally, the functionality of components of the electronic device 700 may be implemented in a single computing cluster or multiple computing machines capable of communicating over a communication connection. Thus, the electronic device 700 may operate in a networked environment using logical connections with one or more other servers, network personal computers (PCs), or another network node.

The input device 750 may be one or more input devices such as a mouse, a keyboard, a trackball, or the like. The output device 760 may be one or more output devices, such as a display, a speaker, a printer, or the like. The electronic device 700 may also communicate with one or more external devices (not shown) through the communication unit 740 as needed, external devices such as storage devices, display devices, etc., communicate with one or more devices that enable a user to interact with the electronic device 700, or communicate with any device (e.g., a network card, a modem, etc.) that enables the electronic device 700 to communicate with one or more other electronic devices. Such communication may be performed via an input/output (I/O) interface (not shown).

According to example implementations of the present disclosure, there is provided a computer-readable storage medium having computer-executable instructions stored thereon, wherein the computer-executable instructions are executed by a processor to implement the method described above. According to example implementations of the present disclosure, a computer program product is further provided, the computer program product being tangibly stored on a non-transitory computer-readable medium and including computer-executable instructions, the computer-executable instructions being executed by a processor to implement the method described above.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce means to implement the functions/actions specified in the flowchart and/or block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/actions specified in the flowchart and/or block diagram(s).

The computer-readable program instructions may be loaded onto a computer, other programmable data processing apparatus, or other apparatus, such that a series of operational steps are performed on a computer, other programmable data processing apparatus, or other device to produce a computer-implemented process such that the instructions executed on a computer, other programmable data processing apparatus, or other device implement the functions/actions specified in one or more blocks in the flowchart and/or block diagram.

The flowchart and block diagrams in the figures show architecture, functionality, and operation of possible implementations of systems, methods, and computer program products according to various implementations of the present disclosure. In this regard, each block in the flowchart or block diagram may represent a module, program segment, or portion of an instruction that includes one or more executable instructions for implementing the specified logical function.

In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are illustrative, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

I/we claim:

1. A method of processing information, comprising:
generating aggregation information associated with a target object based on historical interaction information of the target object, the historical interaction information being generated based on a set of interaction events between the target object and at least one service component; and
providing the aggregation information for interaction between the target object and a digital assistant.

2. The method of claim 1, wherein the historical interaction information comprises a plurality of elements corresponding to different types, and generating the aggregation information associated with the target object comprises:
determining a correlation between at least two of the plurality of elements of the historical interaction information; and
generating the aggregation information for indicating the correlation.

3. The method of claim 1, wherein the aggregation information is used to describe a characteristic of an associated entity of the target object and/or a characteristic of the target object.

4. The method of claim 3, wherein the associated entity of the target object comprises:
a group associated with the target object;
an organization associated with the target object;
a project associated with the target object.

5. The method of claim 1, wherein generating the aggregation information associated with the target object comprises:
generating fourth information based on the historical interaction information;
providing the fourth information to an aggregation model to generate the aggregation information.

6. The method of claim 1, further comprising:
obtaining first information input by the target object to the digital assistant; and
generating, based at least on the first information and the aggregation information, second information as a response of the digital assistant to the first information.

7. The method of claim 6, wherein generating the second information based on at least the first information and the aggregation information comprises:
processing the first information based on the aggregation information to generate third information;
providing the third information to a target processing entity; and
generating the second information based on a processing result of the third information by the target processing entity.

8. The method of claim 7, wherein the third information comprises guidance information, and the target processing entity comprises a target model.

9. The method of claim 6, wherein the aggregation information comprises a set of description entries, and generating the second information based at least on the first information and the aggregation information comprises:
determining at least one description entry associated with the first information from the set of description entries; and
generating the second information based on the first information and the at least one description entry.

10. The method of claim 9, wherein the first information indicates a search requirement regarding a specific content,
determining the at least one description entry associated with the first information from the set of description entries comprises: determining a matching first description entry from the set of description entries based on the first information and/or a target attribute of the first information, wherein the first description entry indicates historical interaction attribute information of the target object,
wherein the generated second information indicates a recommendation content generated based on the first description entry.

11. The method of claim 9, wherein the first information indicates a content creation requirement,
determining the at least one description entry associated with the first information from the set of description entries comprising: determining a matching second description entry from the set of description entries, wherein the second description entry indicates creation attribute information of the target object,
wherein the generated second information indicates a creation content generated based on the second description entry.

12. The method of claim 11, wherein the first information further indicates a historical content for reference, and the matching second description entry is generated based on a historical interaction event associated with the historical content.

13. The method of claim 1, further comprising:
generating a recommendation content for the target object based on the aggregation information, to cause the digital assistant to provide the recommendation content.

14. The method of claim 13, wherein the recommendation content comprises:
at least one recommendation content for inputting to a target input control; and/or
at least one recommendation content for inputting to the digital assistant.

15. The method of claim 13, wherein the recommendation content comprises a content related to at least one planned event of the target object, wherein the at least one future plan is determined based on the aggregation information.

16. The method of claim 13, wherein the at least one planned event is determined based on a periodic characteristic indicated by the aggregation information to indicate that the target object is expected to participate in the planned event according to a particular time period.

17. The method of claim 1, wherein the historical interaction information comprises at least one of the following:
a knowledge element for describing a service object corresponding to a respective interaction event;
an action element for indicating an event type of the respective interaction event; and
a time element for indicating an occurrence time of the respective interaction event.

18. A method of processing information, comprising:
receiving first information input by a target object to a digital assistant, the first information indicating a content creation requirement; and
providing a creation content to the target object with the digital assistant, the creation content being generated based on aggregation information associated with the target object, the aggregation information being generated based on historical interaction information between the target object and at least one service component.

19. The method of claim 18, wherein the historical interaction information is generated based on a set of interaction events between the target object and the at least one service component, the aggregation information at least indicates creation attribute information of the target object, and the creation attribute information is determined based on a creation attribute of at least one service object corresponding to the set of interaction events.

20. An electronic device includes:
at least one processing unit; and
at least one memory coupled to the at least one processing unit and storing instructions for execution by the at least one processing unit, the instructions, when executed by the at least one processing unit, causing the electronic device to perform the method of claim 1.
